(19) United States
(12) Patent Application Publication
(10) Pub. No.: US 2025/0008185 A1
(43) Pub. Date: Jan. 2, 2025

(54) Updating Group View Profiles

(71) Applicant: Rovi Product Corporation, San Jose, CA (US)

(72) Inventors: Govind Raveendranathan Nair, Bengaluru (IN); Sangeeta Parida, Bengaluru (IN); VasanthRaj Rajanna, Bengaluru (IN); Gudimetla Baby, Andra Pradesh (IN)

(21) Appl. No.: 18/214,878

(22) Filed: Jun. 27, 2023

(51) Int. Cl. H04N 21/454; H04N 21/442; H04N 21/466

(52) U.S. Cl. CPC H04N 21/454; H04N 21/44204; H04N 21/44213; H04N 21/4661

(57) ABSTRACT

Generally disclosed herein is a system and method for automatically updating individual viewer profiles based on group viewing of streaming content on a common screen. Particular streaming content may be marked for group viewing. One or more viewing groups may be defined, wherein the viewing groups are linked to individual profiles corresponding to multiple individual viewers. When a viewing group views the particular streaming content, viewing progress may be marked on each of the individual profiles corresponding to the multiple individual viewers in the group. When one or more individual members of a group view the particular content independently, viewing progress of those individual members may be published to other members of the viewing group. In this regard, the other members of the viewing group can catch up.

### BACKGROUND

It is very common for family and friends to watch streaming content together using a common screen. During the physical group watch session, the streaming content may be played from a profile of only one user. In this scenario, only one profile is updated despite that multiple users watch the same streaming content on a common screen. The pause point or progress bar update may only be reflected on the profile of only one user. Because the profiles of the other users are not updated, the other users may receive recommendations to watch the same streaming content when they log on using their own profile. Moreover, if the streaming content is an episode in a series, a streaming platform may begin streaming the episode that the other user already watched with the group, instead of queuing to the next episode, when the other user logs in with their own profile.

### BRIEF SUMMARY

Generally disclosed herein is a mechanism to mark streaming progress on profiles of all users who have watched the streaming content together on a common screen. A group view profile, distinct from the individual profiles, may be generated and updated Based on the group viewing, the streaming progress of the individual profiles corresponding to members in the group view is updated. The group view profile may also indicate streaming status of particular streaming content for individual group members, for example to indicate which group members have viewed the particular streaming content individually.

An aspect of the disclosure provides a system for updating profiles of a plurality of viewers based on streaming progress for a group viewing. The system includes one or more processors and memory in communication with the one or more processor, wherein the memory contains instructions configured to cause the one or more processors to receive a request from a first user to access requested content, the first user associated with a first user profile. The instructions are also configured to cause the one or more processors to determine that one or more additional user profiles are associated with the requested content in a group viewing context with the first user. The instructions are further configured to cause the one or more processors to determine viewers, including the first user and which respective users associated with the one or more additional user profiles in the group viewing context, to view the requested content. The instructions are also configured to cause the one or more processors to monitor a viewing progress of the requested content by each viewer. The instructions are further configured to cause the one or more processors to update a respective user profile for each viewer based on the viewing progress of the requested content.

In another example, the instructions are further configured to cause the one or more processors to monitor a viewing progress of the requested content by a viewer in the viewing group when the viewer watches the media content independently of other members in the viewing group.

In yet another example, the instructions are further configured to cause the one or more processors to determine whether each viewer in the viewing group is allowed to view the requested content.

In yet another example, the instructions are further configured to cause the one or more processors to generate a catch-up list of the requested content based on the viewing progress of the requested content by each viewer.

In yet another example, the instructions are further configured to cause the one or more processors to provide the catch-up list to other viewers in the viewing group and track a progress of the other viewers in watching the content on the catch-up list.

In yet another example, the instructions are further configured to cause the one or more processors to generate a group viewing profile.

In yet another example, the instructions are further configured to cause the one or more processors to disable one or more of the plurality of viewers from watching the requested content through the group viewing profile based on age appropriateness for the requested content.

Another aspect of the disclosure provides for a method for updating profiles of a plurality of viewers based on streaming progress for a group viewing. The method includes receiving, by one or more processors, a request from a first user to access requested content, the first user associated with a first user profile. The method also includes determining, by the one or more processors, that one or more additional user profiles are associated with the requested content in a group viewing context with the first user. The method further includes determining, by the one or more processors, viewers, including the first user and which respective users associated with the one or more additional user profiles in the group viewing context, to view the requested content. The method also includes monitoring, by the one or more processors, a viewing progress of the requested content by each viewer. The method further includes updating, by the one or more processors, a respective user profile for each viewer based on the viewing progress of the requested content.

In another example, the method further includes monitoring a viewing progress of the requested content by a viewer in the viewing group when the viewer watches the media content independently of other members in the viewing group.

In yet another example, the method further includes determining whether each viewer in the viewing group is allowed to view the requested content.

In yet another example, the method further includes generating a catch-up list of the requested content based on the viewing progress of the requested content by each viewer.

In yet another example, the method further includes providing the catch-up list to other viewers in the viewing group and tracking a progress of the other viewers in watching the content on the catch-up list.

In yet another example, the method further includes generating a group viewing profile.

In yet another example, the method further includes disabling one or more of the plurality of viewers from watching the requested content through the group viewing profile based on age appropriateness for the requested content.

The above and other aspects of the disclosure can include one or more of the following features. In some examples, aspects of the disclosure provide for all of the following features in combination.

In an example, the catch-up list of the requested content includes information indicating which one or more users to complete the catch-up list of the requested content.

In another example, the group viewing is prevented until each viewer completes viewing the catch-up list of the requested content.

In yet another example, a viewer is blocked from accessing the group viewing profile for group viewing when the viewer's viewing progress is ahead of other viewers' viewing progresses.

### BRIEF DESCRIPTION OF THE DRAWINGS

FIG. 1 depicts a block diagram illustrating a sequence of episodes of streaming content based on individual and/or group viewing according to aspects of the disclosure.

FIG. 2 depicts a block diagram illustrating a generation of a group view profile according to aspects of the disclosure.

FIG. 3 depicts a block diagram illustrating multiple group view profiles according to aspects of the disclosure.

FIG. 4 depicts a block diagram illustrating accessing streaming content through a group view profile according to aspects of the disclosure.

FIG. 5 depicts a flow diagram illustrating an update of profiles based on a group view progress according to aspects of the disclosure.

FIG. 6 depicts a block diagram illustrating a group view profile being updated based on the user's presence according to aspects of the disclosure.

FIG. 7 depicts a block diagram illustrating individual profile progress according to aspects of the disclosure.

FIG. 8 depicts a block diagram illustrating two different individual profile progresses according to aspects of the disclosure.

FIG. 9 depicts a block diagram illustrating an example catch-up list generated based on individual profile progress according to aspects of the disclosure.

FIG. 10 depicts a block diagram of another example of a catch-up list generated based on individual profile progress according to aspects of the disclosure.

FIG. 11 depicts a block diagram illustrating a different view for profiles based on a catch-up list according to aspects of the disclosure.

FIG. 12 depicts a block diagram illustrating an example restriction on a group view according to aspects of the disclosure.

FIG. 13 depicts a block diagram of another example restriction on a group view according to aspects of the disclosure.

FIG. 14 depicts a block diagram of an example streaming content group viewing system according to aspects of the disclosure.

FIG. 15 depicts a flow diagram of an example method for updating a group view profile according to aspects of the disclosure.

FIG. 16 depicts a flow diagram of another example method for updating a group view profile according to aspects of the disclosure.

### DETAILED DESCRIPTION

Generally disclosed herein is a system and method for automatically updating individual viewer profiles based on group viewing of streaming content on a common screen. Particular streaming content may be marked for group viewing. The particular streaming content may include, for example, a series of episodes, one or more movies, a series of podcasts, video clips, etc. Moreover, one or more viewing groups may be defined, wherein the viewing groups are linked to individual profiles corresponding to multiple individual viewers. When a viewing group views the particular streaming content, viewing progress may be marked on each of the individual profiles corresponding to the multiple individual viewers in the group. When one or more individual members of a group view the particular content independently, the viewing progress of those individual members may be published to other members of the viewing group. In this regard, the other members of the viewing group can catch up.

A single streaming account may have multiple associated profiles. For example, a household may have one account with a given streaming media service, such that one subscription is issued, or one bill is routinely paid for the given streaming service. However, if the household includes multiple family members, each member may have their own profile included as part of the same account. A viewing group may be established for any two or more viewer profiles, such as profiles on the same account and/or profiles on different accounts or in different households. Moreover, an individual viewer may belong to multiple different viewing groups. According to some examples, content for group viewing by a particular viewing group may be selected and marked for group viewing in advance, prior to a time of viewing, by one or more members of the group. In other examples, particular content may be designated for group viewing upon detection of members of the viewing group being present before the common display.

The creation of a viewing group may be performed in a variety of ways. For example, an option to create a group view profile may be selected by a user when the user accesses any streaming content using the user's individual profile. In creating the group view profile, the user may be prompted to enter other users' profile information for the group viewing option. In other examples, the viewing group may be automatically established or suggested at a time of viewing based on the detection of which individuals are watching a common display. For example, detection of which individuals are watching may include image recognition, voice recognition, detection of the presence of user devices such as smartphones or smartwatches, or any of a variety of other detection techniques.

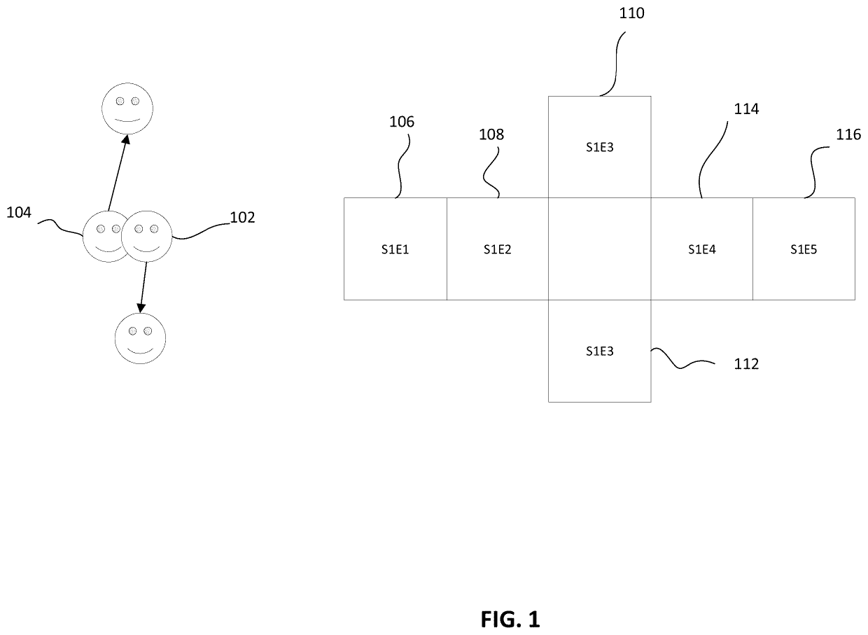

FIG. 1 depicts a block diagram illustrating a sequence of various episodes of streaming content based on individual and/or group viewing. In this example, user 104 and user 102 watch S1E1 106 and S1E2 108 together. For the purpose of this disclosure, “S” may refer to a series of streaming content, and “E” may refer to an episode of the series of streaming content. S1E1 106 may refer to the first episode of the first series of a video series. Users 104 and 102 may watch up to S1E2 108 together. User 104 may want to watch S1E3 (110) alone while user 102 may want to watch S1E3 (112) alone. The streaming content group viewing system may store information indicating that user 104 watched S1E3 110 and user 102 watched S1E3 112 individually. For example, the system may update a group profile for the viewing group and/or update the individual profiles of both user 102 and user 104 accordingly. When both users 102 and user 104 start to watch S1E4 114 together, such as on a common display, the streaming content group viewing system may access the group view profile and determine that all members of the viewing group are queued up to S1E4. Accordingly, users 102 and 104 may continue to watch S1E4 114 and S1E5 116 and the streaming content group viewing system may update the group view profile accordingly.

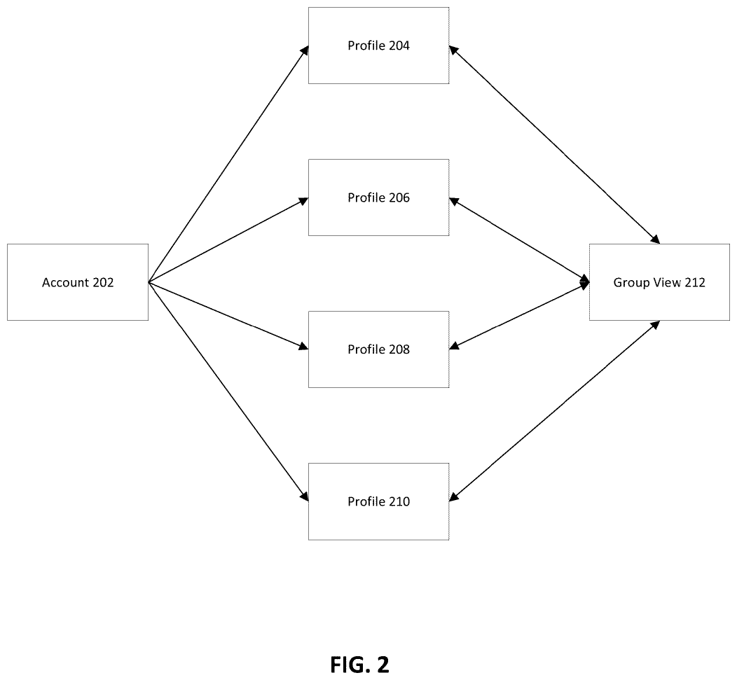

FIG. 2 depicts a block diagram illustrating addition of a group view profile to an existing user account. Account 202 may include profiles 204, 206, 208, 210. Account 202 may refer to an account used, for example, for a family. For example, profile 204 may be an individual profile for the user. Profile 206 may belong to the user's spouse. Profile 208 may belong to the user's first child. Profile 210 may belong to the user's second child. If the user's family members decide to watch an episode of the streaming content as a group, the streaming content group viewing system may create a group view profile 212. Group view profile 212 may be linked to each of profiles 204-210. Each profile 204-210 may access group view profile 212 when all family members sit together and watch the next episode of the streaming content. The streaming content group viewing system may update the progress on group view profile 212. The streaming content group viewing system may also update each profile 204-210.

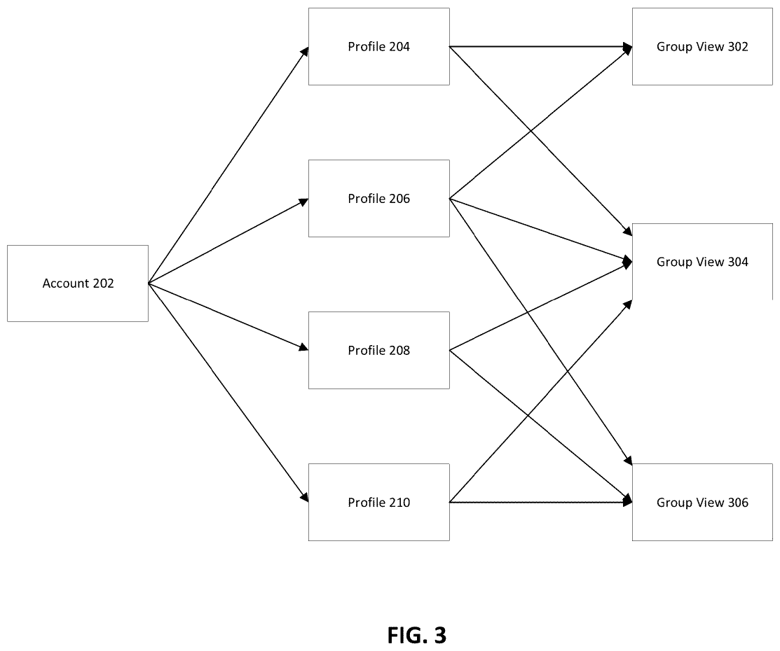

FIG. 3 depicts a block diagram illustrating how multiple group view profiles are created and accessed. Account 202 may generate multiple group view profiles such as group view profiles 302-306 when there is more than one user watching a particular streaming content on the same screen. Each group view profile may be linked to one or more individual profiles 204-210. Each group view profile may be associated with a distinct television, video, or movie series, or other type of content series. For example, group view profile 302 may be associated with a series of a soap drama, group view profile 304 may be associated with an animation series and profile 406 may be associated with a variety show. In some examples, one group view profile may be associated with multiple series.

A given individual profile may correspond to some group view profiles but not others. For example, profile 204 may have access to group view profile 302 and 304 and not group view profile 306 because the viewer linked to profile 204 may not want to or never watched the variety show with other family members. Profile 206 may have access to all of the group view profiles 304-306. The viewer linked to profile 206 may view the soap drama, the animation series, and the variety shows with other family members. Profiles 208 and 210 may access group view profiles 304 and 306 and not group view profile 302 because the users associated with profiles 208-210 may not want to watch the soap drama linked to group view profile 302.

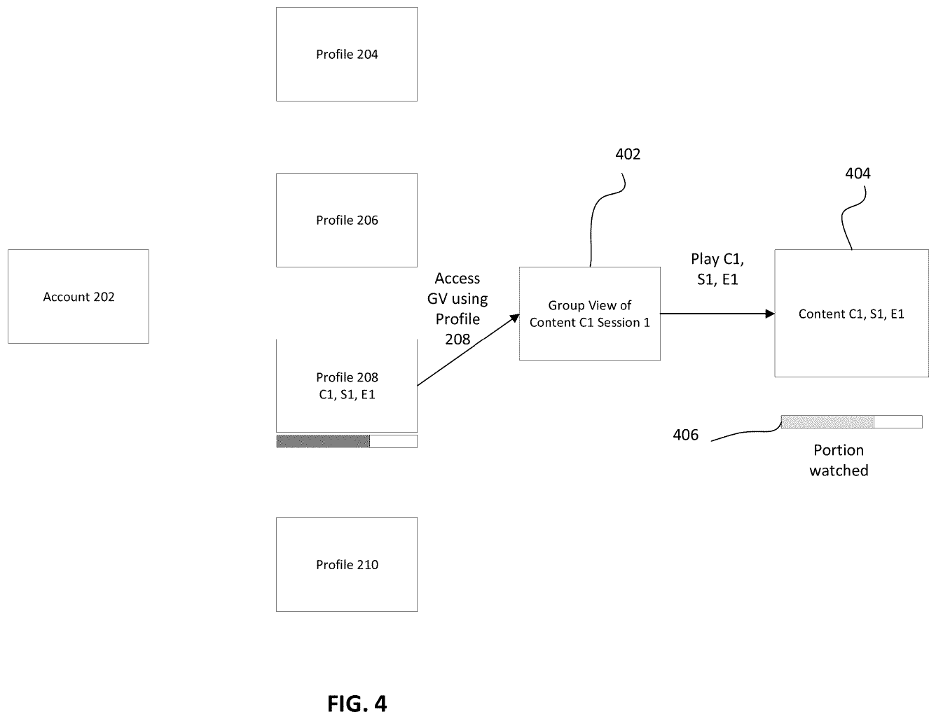

FIG. 4 depicts a block diagram illustrating accessing streaming content through a group view profile. According to some examples, any of the profiles 204-210 may be used for streaming via group view. A user may have the option to access a group view profile when the user accesses any streaming content using the user's individual profile. For example, if the user uses profile 208 to access group view profile 402 and starts watching the streaming content 404 on a common display, progress bar 406 indicating the portion watched may be communicated directly to group view profile 402 and then update profile 208 in real-time.

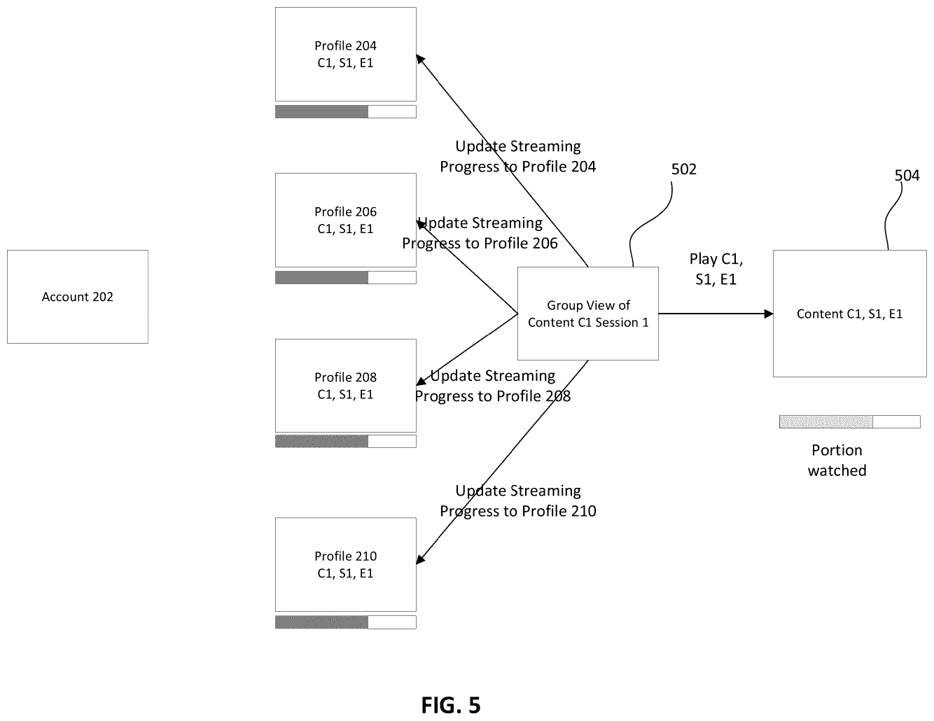

FIG. 5 depicts a flow diagram illustrating an update of user profiles based on a group view progress. According to some examples, any user's profile may be selected to access group viewing of the streaming content, and all the other profiles that have access to group view profile 502 may also be updated with the progress of streaming content 504. In other examples, the user may start streaming the content directly through group view profile 402. Group view profile 402 may send information indicating the portion of the streaming content 504 that has been watched and update profiles 204-210 even if only profile 208 was used to access group view profile 502 when the users associated with profiles 204-210 and began watching streaming content 504 as a group.

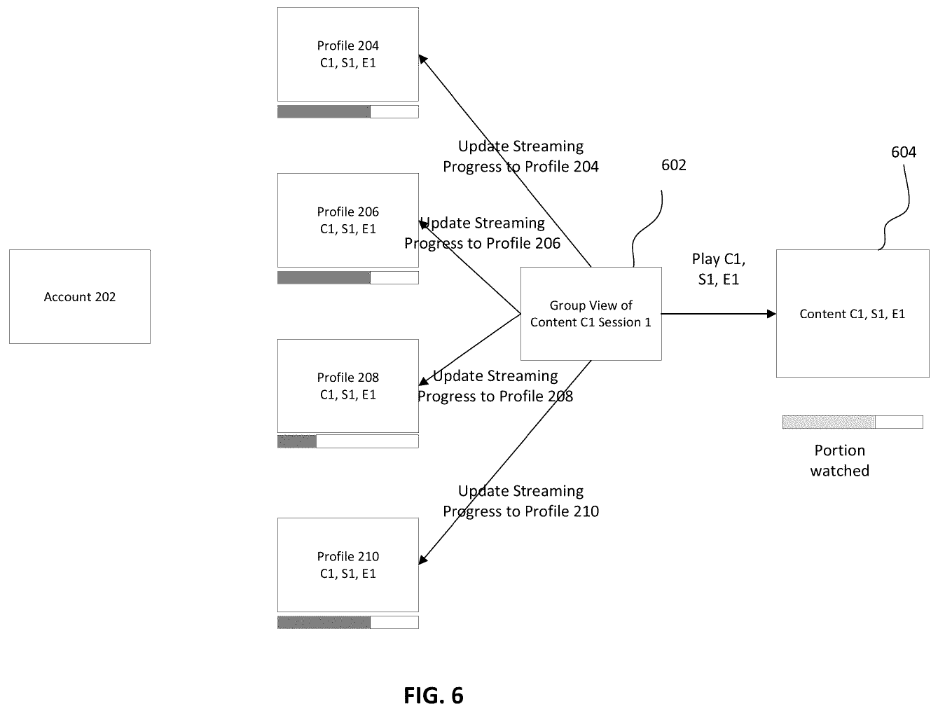

FIG. 6 depicts a block diagram illustrating a group view profile updating viewing progress for a plurality of different users based on each user's presence. When multiple users are viewing the streaming content, the group viewing profile may be updated based on the viewing progress. Moreover, each individual profile for users in the viewing group may also be updated based on the viewing progress. If one of the group viewers leaves the viewing area and is no longer watching the streaming content, the individual profile for that viewer may cease updating the viewing progress. That viewer's individual profile will reflect a viewing progress up until the point the viewer ceased watching.

In the example shown, profile 208 may be associated with the viewer who steps out of the watching room and stops watching the streaming content 604. The viewer's presence and/or departure may be detected automatically, such as by a camera or other type of sensor in the viewing area. For example, a camera attached to the TV may monitor the activities of each viewer. The camera may receive visual input indicating that a given viewer has exited for a threshold time. When this is detected, the streaming content group viewing system stops updating the progress on profile 208 in real time. Group view profile 602 may continue to update profiles 204, 206, and 210 as long as the users associated with those profiles remain within the monitoring zones and watch the streaming content 604.

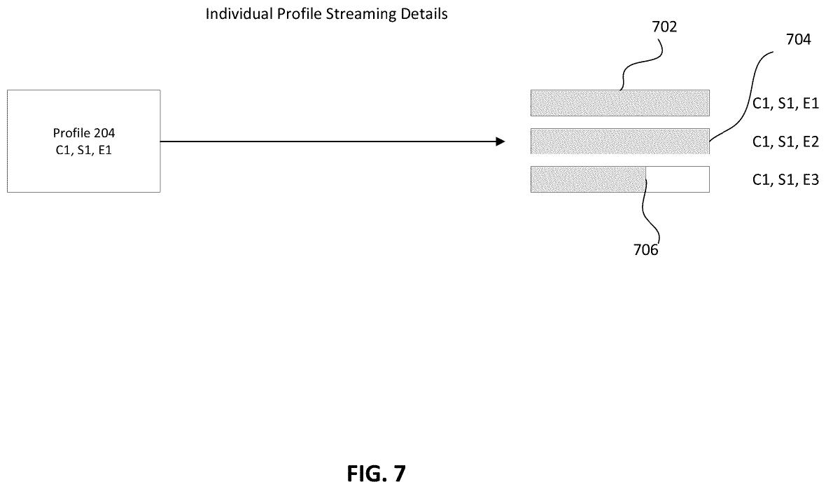

FIG. 7 depicts a block diagram illustrating individual profile progress. In some scenarios, one or more given users in a viewing group may watch the streaming content that is marked for group viewing using the given user's own individual profile and without the other group members. The group view profile may track the updated viewing progress by the given user of the streaming content marked for group viewing. For example, if a user associated with profile 204 went on to further watch streaming content 702, 704, and 706, profile 204 may be updated to track of the progress of each episode the user has watched. In this example, the user has finished watching the streaming content 702 and 704 and watched a portion of the streaming content 706. The group view profile may include an indication of the individual user's viewing progress of each streaming content 702, 704, 706. In this regard, other members of the viewing group can see the user's viewing progress and can view the same content independently to catch up, without waiting for the entire viewing group to be present. Therefore, each viewer may have options to either view the streaming content individually without other viewing group members or view the streaming content when the other viewing group members are available without having to manually update the individual viewing progress.

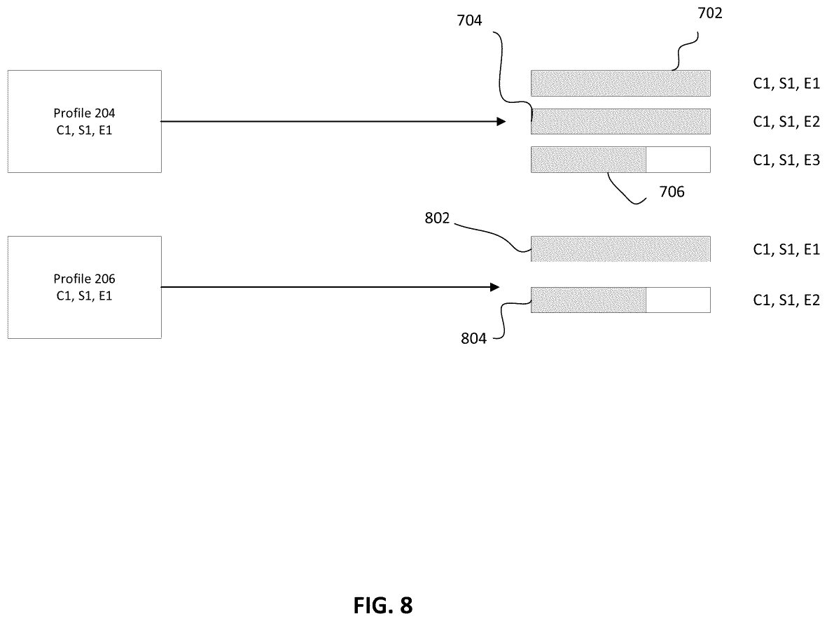

According to some examples, the streaming content group viewing system may monitor individual viewing progress of multiple viewers that are viewing the content independently of one or more other members in the viewing group. FIG. 8 illustrates an example of monitoring progress of two different individual profiles. For example, the system may keep track of the completed episodes for profile 204 and profile 206. In this example, a user associated with profile 206 finished watching the streaming content 1 series 1 episode 1, as indicated by progress bar 802, and portions of content 1 series 1 episode 2, as indicated by progress bar 804. The user associated with profile 204 finished watching both episodes 1 and 2, as indicated by progress bars 702 and 704, respectively, and portions of episode 3, as indicated by progress bar 706. The system may store the viewing progress for each profile. In this regard, other members of a viewing group can be informed as to a viewing status of the content by each other member in the viewing group.

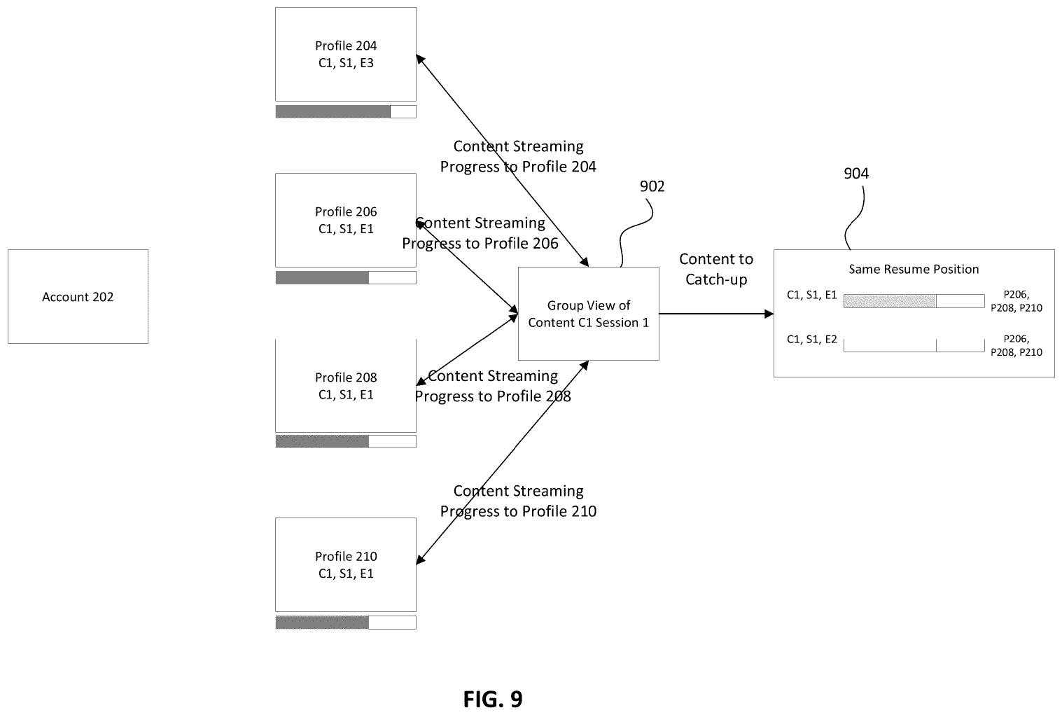

FIG. 9 depicts a block diagram illustrating an example catchup list generated based on individual profile progress. According to some examples, the progress of individual profile 204 may be fetched and published in group view profile 902 such that the other users associated with profiles 206, 208, and 210 may catch up. In this example, the user associated with profile 204 finished viewing C1, S1, E1, and C1, S1, E2 and is currently viewing C1, S1. E3. The system may notify the users in group view profile 902 about the individual progress of profile 204 and maintain a catch-up list 904 associated with profiles 206-210 to finish watching the content up to the progress bar indicated in the catch-up list 904 before every user in the group can sit together and resume the group viewing of the streaming content.

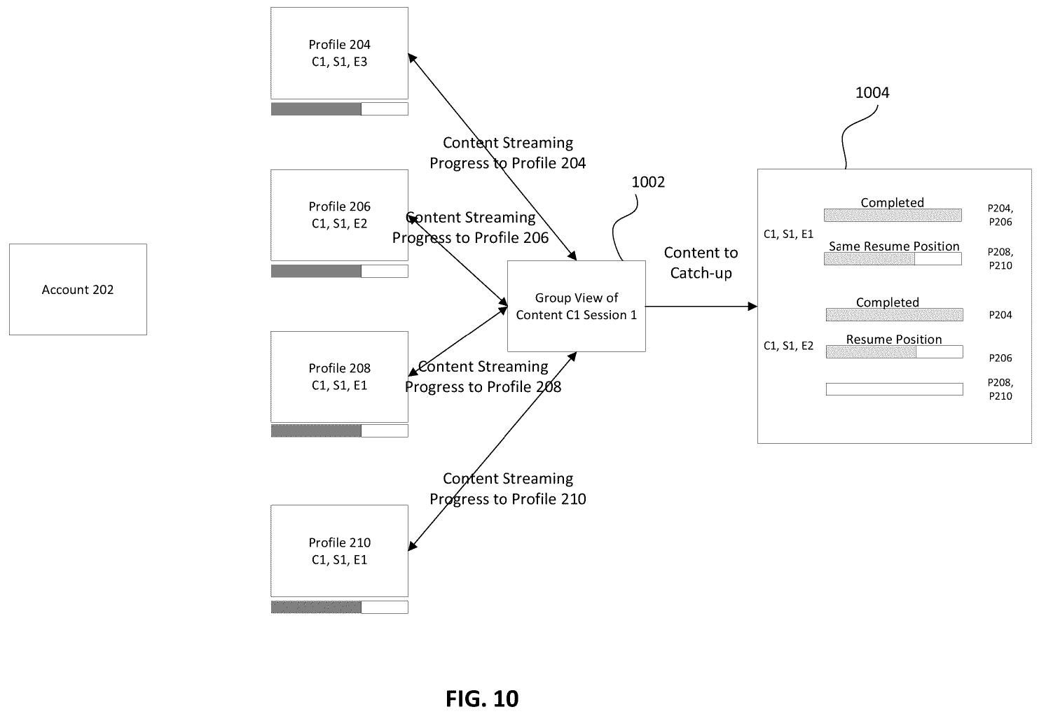

FIG. 10 depicts a block diagram of another example catch-up list generated based on individual profile progress. In this example, the user associated with profile 204 and the user associated with 206 watched the streaming content outside the group view. Group view profile 1002 may be updated to reflect information relating to the individual progress made by the users associated with profiles 204 and 206 to generate a catch-up list 1004. Based on the catch-up list 1004, the user associated with profile 208 and the user associated with profile 210 may be encouraged to finish watching C1.S1.E1 and C1.S1.E2 before the users associated with profiles 206-210 watch the rest of C1.S1.E2 together.

According to some examples, the user associated with a profile that has made the farthest progress may be prevented from accessing the group view profile and streaming the content marked for group viewing until other users catch up with the farthest progress. In other examples, the user may be prompted to choose an option to skip the catch-up list and resume watching the streaming content ahead of the catch-up list individually. In such a scenario, the user may be prompted to exit the viewing group and the group view profile may be updated accordingly. In other examples, the user may be prompted to re-watch the streaming content with the viewing group. In some examples, a user with viewing progress that lags behind those of other members of the group viewing may be prompted to exit the viewing group or skip the catch-up list. In some examples, the user with the lagging viewing progress may be allowed to request a summary of what was covered in the missed episodes from the catch-up list. Such summaries may be extracted from the news or reporting magazines or generated based on highlights of the episodes.

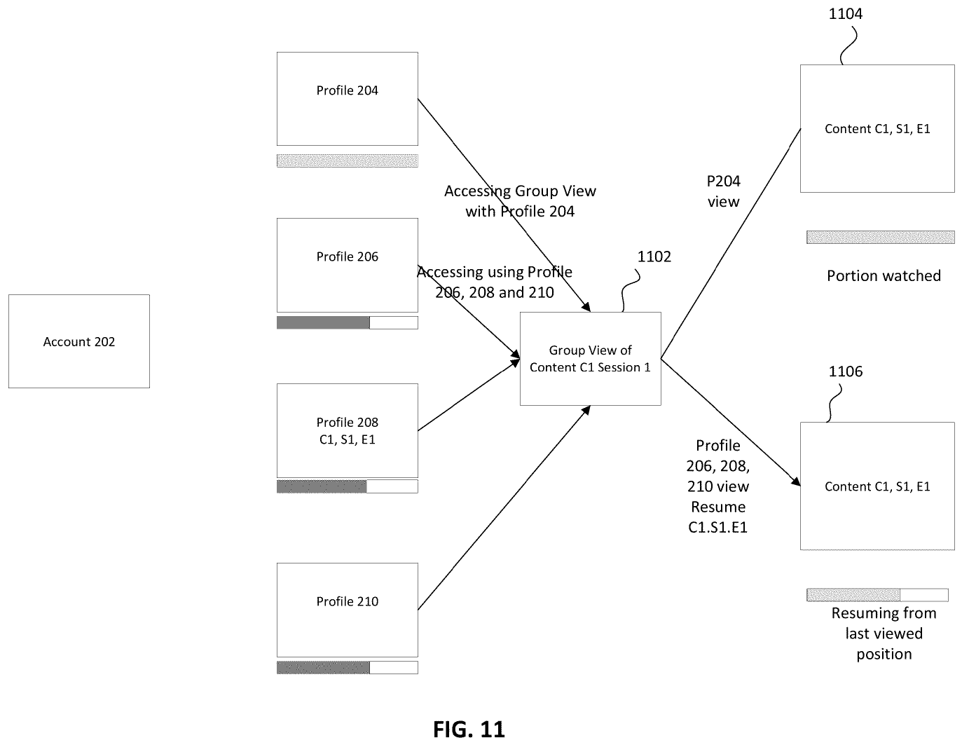

FIG. 11 depicts a block diagram illustrating a different view for profiles based on a catch-up list. In this example, the user associated with profile 204 has already finished watching the streaming content 1104. Streaming content 1103 may provide the user associated with profile 204 with a warning sign to wait for other users to catch up with the progress. For example, if the user associated with profile 204 attempts to begin streaming the next episode in the series, and the other group members of the viewing group are not detected to be watching on the same display, a prompt may be displayed encouraging the user associated with profile 204 to wait for the other group members. The other users associated with profiles 206-210 may resume watching the streaming content 1105 without the user associated with profile 204. Streaming content 1104 and streaming content 1106 may refer to the same content C1.S1.E1.In this example, the user associated with profile 204 may be prompted to display the progress bar indicating the full progress and a message for the user to wait for the other users. On the other hand, streaming content 1106 may be displayed to the users associated with profiles 206, 208, and 210 with the progress bar marked for the previously viewed position. In some examples, each user associated with each profile 204-210 may access the group view profile and resume group viewing of the same streaming content on individual screens without sitting together in the same space. In this example, the user associated with profile 204 may be prevented from accessing the group view profile and/or watching the content since the user's progress is ahead of those of the other users.

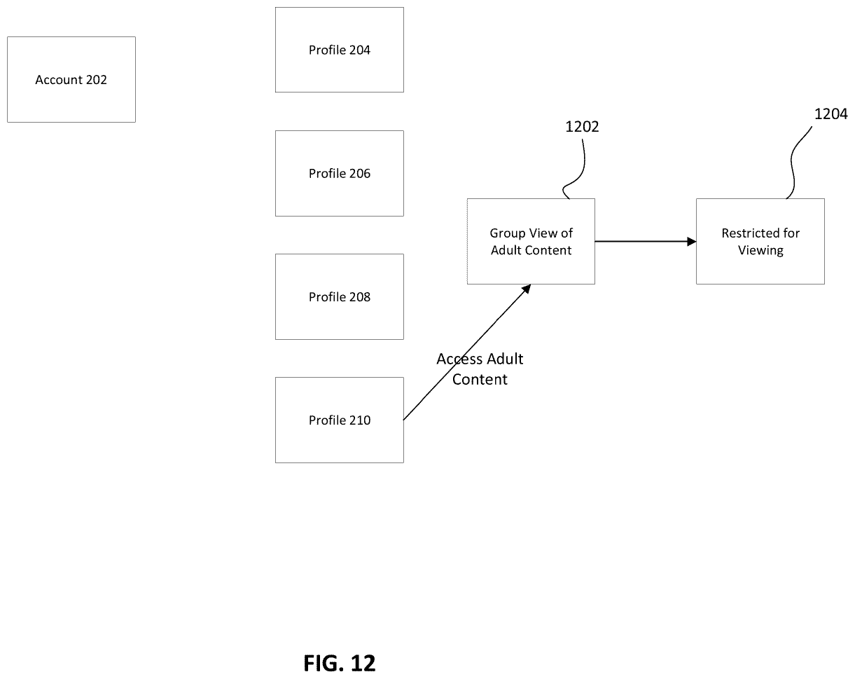

FIG. 12 depicts a block diagram illustrating a restriction on group viewing. According to some examples, group view may be enabled or disabled based on the ages of the users and the context of the streaming content. For example, the users associated with profiles 204-208 may be adults and the user associated with profile 210 may be a minor. Group view profile 1202 may have a content list: 5 age-appropriate content, 1 adult content, and 3 horror content. When the minor user tries to access group view profile 1202, the system may interfere with the group viewing of some of the streaming content listed in group view profile 1202 such as adult or horror content. For example, the system may skip over particular portions of the streaming content when a minor user is viewing the content. The system may refuse to play the streaming content when the minor user is attempting to view the streaming content with other adult users. In other examples, the system may ask for parental permission or remove the minor user from the particular group view profile for the future.

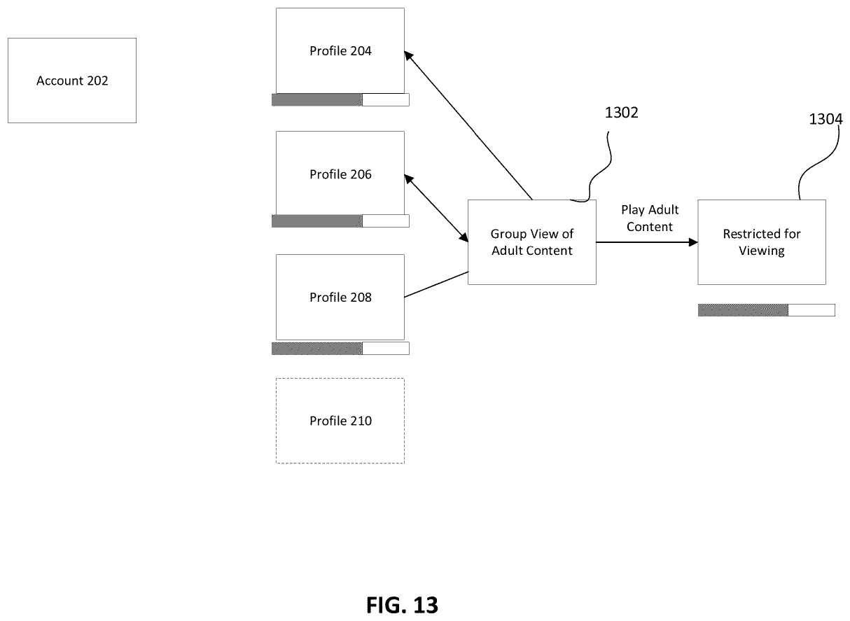

FIG. 13 depicts a block diagram of another example restriction on a group view. According to some examples, if an adult user tries to access the group view profile 1302 to watch adult content, the system may restrict access from profile 210 and make sure only the users associated with profile 204-20 may watch the adult content. Group view profile 1302 may only update the progress of profiles 204-208, not 210. Even though the minor user is disabled from watching the adult content in this example, the minor user's profile 210 may be enabled again when any one of the users tries to watch age-appropriate content with the minor user. In some examples, a single group view profile may keep track of the group progress of multiple contents and communicate with each individual profile for updates.

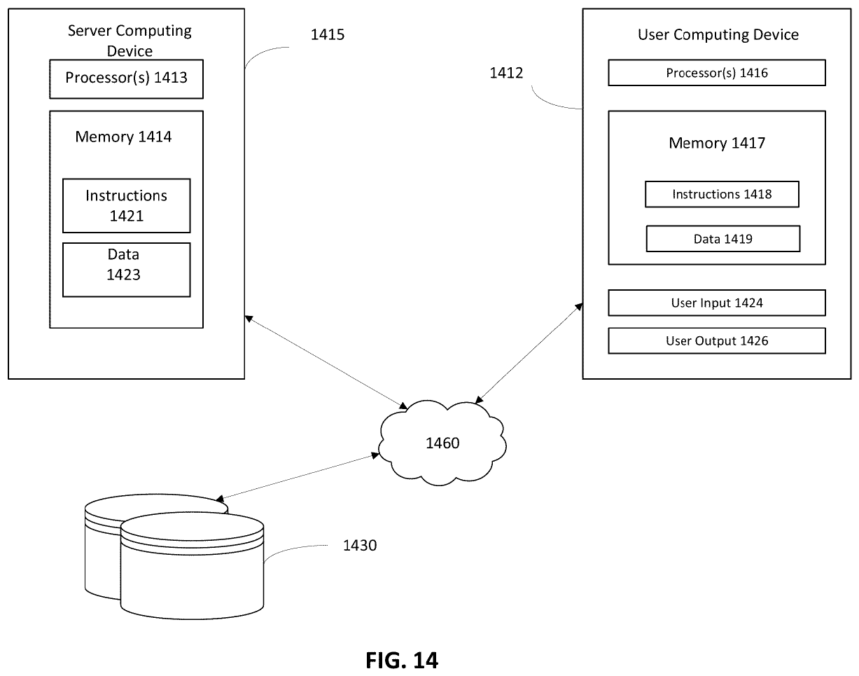

FIG. 14 depicts a block diagram of an example streaming content group viewing system. User computing device 1412 and server computing device 1415 can be communicatively coupled to one or more storage devices 1430 over a network 1460. The storage device(s) 1430 can be a combination of volatile and non-volatile memory and can be at the same or different physical locations than the computing devices 1412, 1415. For example, the storage device(s) 1430 can include any type of non-transitory computer-readable medium capable of storing information, such as a hard drive, solid state drive, tape drive, optical storage, memory card, ROM, RAM, DVD, CD-ROM, write-capable, and read-only memories.

The server computing device 1415 can include one or more processors 1413 and memory 1414. Memory 1414 can store information accessible by the processor(s) 1413, including instructions 1421 that can be executed by the processor(s) 1413. Memory 1414 can also include data 1423 that can be retrieved, manipulated, or stored by the processor(s) 1413. Memory 1414 can be a type of non-transitory computer-readable medium capable of storing information accessible by the processor(s) 1413, such as volatile and non-volatile memory. The processor(s) 1413 can include one or more central processing units (CPUs), graphic processing units (GPUs), field-programmable gate arrays (FPGAs), and/or application-specific integrated circuits (ASICs), such as tensor processing units (TPUs).

Instructions 1421 can include one or more instructions that when executed by the processor(s) 1413, cause one or more processors to perform actions defined by the instructions. Instructions 421 can be stored in object code format for direct processing by the processor(s) 1413, or in other formats including interpretable scripts or collections of independent source code modules that are interpreted on demand or compiled in advance. Instructions 1421 can include instructions for implementing processes consistent with aspects of this disclosure. Such processes can be executed using the processor(s) 1413, and/or using other processors remotely located from the server computing device 1415.

The data 1423 can be retrieved, stored, or modified by the processor(s) 1413 in accordance with instructions 1421. Data 1423 can be stored in computer registers, in a relational or non-relational database as a table having a plurality of different fields and records, or as JSON, YAML, proto, or XML documents. Data 1423 can also be formatted in a computer-readable format such as, but not limited to, binary values, ASCII, or Unicode. Moreover, data 1423 can include information sufficient to identify relevant information, such as numbers, descriptive text, proprietary codes, pointers, references to data stored in other memories, including other network locations, or information that is used by a function to calculate relevant data.

User computing device 1412 can also be configured similarly to the server computing device 1415, with one or more processors 1416, memory 1417, instructions 1418, and data 1419. The user computing device 1412 can also include a user output 1426, and a user input 1424. The user input 1424 can include any appropriate mechanism or technique for receiving input from a user, such as a keyboard, mouse, mechanical actuators, soft actuators, touch screens, and microphones. User computing device 1412 may include cameras and/or other sensors that may be used to detect a viewer of the streaming content in real time. Such other sensors may include, for example, radio frequency sensors, ultra-wideband, heat sensors, motion sensors, proximity sensors, audio sensors, or any other type of sensors. User computing device 1412 may be, for example, a laptop, smart television, smartphone, or other computing device with a display. In other examples, the computing device may include a streaming device in communication with a display.

Server computing device 1415 can be configured to transmit data to the user computing device 1412, and the user computing device 1412 can be configured to display at least a portion of the received data on a display implemented as part of the user output 1426. The user output 1426 can also be used for displaying an interface between the user computing device 1412 and the server computing device 1415. The user output 1426 can alternatively or additionally include one or more speakers, transducers, or other audio outputs, a haptic interface, or other tactile feedback that provides non-visual and non-audible information to the platform user of the user computing device 1412.

Although FIG. 14 illustrates the processors 1413, 1416 and the memories 1414, 1417 as being within the computing devices 1415, 1412, components described in this specification, including the processors 1413, 1416 and the memories 1414, 1417 can include multiple processors and memories that can operate in different physical locations and not within the same computing device. For example, some of the instructions 1421, 1418 and the data 1423, 1419 can be stored on a removable SD card and others within a read-only computer chip. Some or all of the instructions and data can be stored in a location physically remote from, yet still accessible by, the processors 1413, 1416. Similarly, processors 1413, 1416 can include a collection of processors that can perform concurrent and/or sequential operations. Computing devices 1415, 412 can each include one or more internal clocks providing timing information, which can be used for time measurement for operations and programs run by computing devices 1415, 1412.

The server computing device 1415 can be configured to receive requests to process data from the user computing device 1412. For example, environment 1400 can be part of a computing platform configured to provide a variety of services to users, through various user interfaces and/or APIs exposing the platform services. One or more services may be online multi-user event participation. The user computing device 1412 may receive and transmit data related to an online multi-user event participants' state, profile information, historical data, etc.

Devices 1412, 1415 can be capable of direct and indirect communication over network 1460. Devices 1412, 1415 can set up listening sockets that may accept an initiating connection for sending and receiving information. The network 1460 itself can include various configurations and protocols including the Internet, World Wide Web, intranets, virtual private networks, wide area networks, local networks, and private networks using communication protocols proprietary to one or more companies. Network 1460 can support a variety of short- and long-range connections. The network 1460, in addition, or alternatively, can also support wired connections between devices 1412, 1415, including over various types of Ethernet connection.

Although a single server computing device 1415 and user computing device 1412 are shown in FIG. 14, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

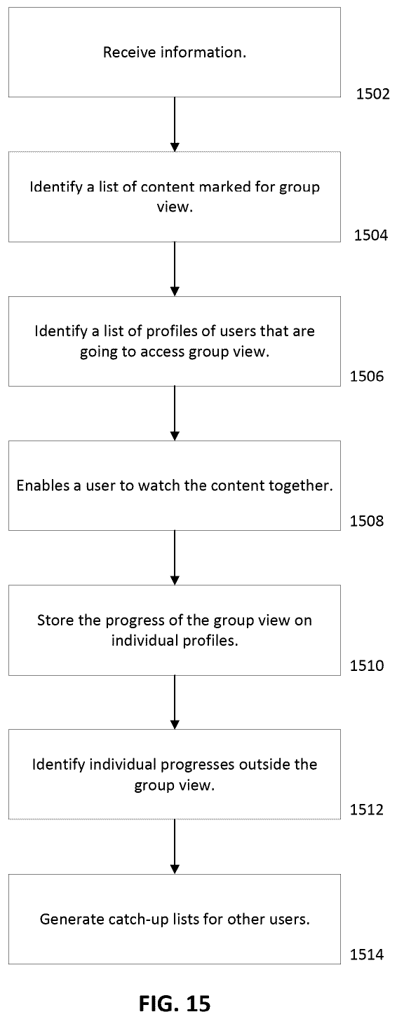

FIG. 15 depicts a flow diagram of an example method for updating a group view profile according to aspects of the disclosure. According to block 1502, the streaming content group viewing system may receive information from a user's account and its associated profiles. For example, if a household has an account for a streaming service, the user may set up multiple profiles for each of the user's family members. At block 1502, the system may also receive a request from the user or any other family member for a particular streaming content, such as a TV drama, variety show, or documentary. Once the system receives the above information and request, the system may check whether there is a list of streaming content marked for group view at block 1504.

According to block 1504, the system may determine whether each profile is linked to a group view profile. The system may also identify content marked for group view. For example, the user account may have a group view profile, and the group view profile may have one or more streaming content marked for group view. In some examples, the system may mark streaming content for group viewing if two or more users watch an episode together on a single screen. The system may mark the streaming content by adding an identifier to the streaming content, such as an icon displayed along with a landing page for the content or a listing for the content, or a data tag associated with a file for the content in a database. The system may prompt the users to input whether the streaming content that is being played should be marked for group view. The users may elect whether or not to mark the particular streaming content for group view. In some examples, different group view profiles may be generated based on a different combination of the members of the family opting to watch a particular streaming content together. For example, if users 1 and 2 decide to watch streaming content as a group, the system may set up a group view profile specifically for users 1 and 2. If users 1, 2, and 3 want to watch different streaming content together as a group, the system may generate a separate group view profile for users 1, 2, and 3.

According to block 1508, the input may be received to begin playing the streaming content marked for group view. According to some examples, the system may include a camera system configured with a facial recognition technique, voice detection system, ultrawideband or RF detection system to identify which users are present and watching together as a group. Based on attributes of the viewers detected, the system may take one or more corresponding actions. For example, for the viewer attribute of age, if the camera system detects a minor when the system receives a request for an adult comedy show, the system may display a warning message or decline to stream the requested content until the minor user leaves the room. In other examples, if the system detects one of the users watching the streaming content steps out of the room and does not come back within a predetermined period of time, the system may pause the streaming content and wait for the user to come back and resume the group view again.

According to block 1510, the system may store the progress of the group view in association with individual profiles. For example, a group view profile may be linked to multiple individual profiles. Once the users associated with those individual profiles finish watching an episode of the streaming content, the system may update the individual profiles with the same information. For example, if the users stop watching the second episode of a drama show at the mid-point, the system may save the progress bar and store the status of the progress bar for each profile associated with the users who watched the episode as a group.

According to block 1512, the system may track the user's individual progress on the episode that was originally marked for group view. For example, if one or more users who had watched the episode as a group decide to continue watching the same episode individually, the system may record the individual user's progress in both the user's profile and the group view profile.

According to block 1514, the system may generate a catch-up list when one or more users individually watch the streaming content originally marked for group view. The individual profile with the most progresses will be benchmarked for a catch-up list. If user 1 makes further progress on the subsequent episodes of the streaming content originally marked for group view, user 1 may be prevented from watching the show any further until the other users catch up to user 1's progress. In some examples, the system may prompt user 1 to select whether to wait until other users catch up or opt out of the group view and continue watching the next episodes individually.

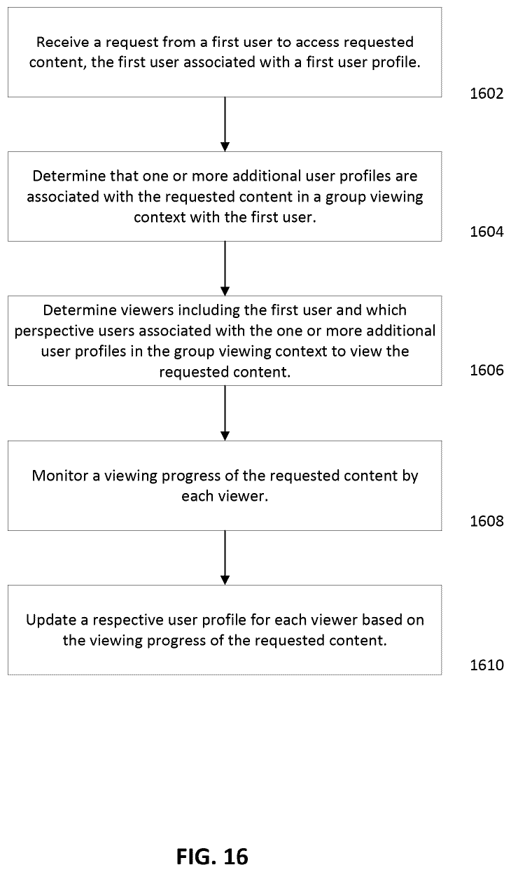

FIG. 16 depicts a flow diagram of another example method for updating a group view profile. According to block 1602, the system may receive a request from a first user to access requested content, the first user associated with a first user profile. The system may stream the requested content using the first user's profile. The user's profile may be associated with one or more group view profiles.

According to block 1604, the system determines that one or more additional user profiles are associated with the requested content in a group viewing context with the first user. According to some examples, the system may first check whether the requested content is marked for group viewing. The system may automatically mark certain content for group viewing if one or more users view the content on a common screen or enable the user to manually mark the content for group viewing.

According to block 1606, the system determines viewers including the first user and which perspective users associated with the one or more additional user profiles in the group viewing context to view the requested content. The system may include various sensors configured to detect other users' presence. If the users other than the first user are determined to be the users associated with the one or more additional user profiles, the system may start streaming the content via the group view profile.

According to block 1608, the system monitors a viewing progress of the requested content by each viewer. The system may allow the users to view the requested content outside the group viewing. If a user views the content independent of other users, the system may keep track of the user's individual progress.

According to block 1610, the system updates a respective user profile for each viewer based on the viewing progress of the requested content. The system may update both the group view profile and individual user profiles. The system may generate a catch-up list based on the individual user profiles and store it with the group view profile.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for updating profiles of a plurality of viewers based on streaming progress for a group viewing, the system comprising:
one or more processors; and
memory in communication with the one or more processors, wherein the memory contains instructions configured to cause the one or more processors to:
receive a request from a first user to access requested content, the first user associated with a first user profile;
determine that one or more additional user profiles are associated with the requested content in a group viewing context with the first user;
determine viewers, including the first user and which respective users associated with the one or more additional user profiles in the group viewing context, to view the requested content;
monitor a viewing progress of the requested content by each viewer; and
update a respective user profile for each viewer based on the viewing progress of the requested content.

2. The system of claim 1, wherein the instructions are further configured to cause the one or more processors to monitor a viewing progress of the requested content by a viewer in the viewing group when the viewer watches the requested content independently of other members in the viewing group.

3. The system of claim 1, wherein the instructions are further configured to cause the one or more processors to determine whether each viewer in the viewing group is allowed to view the requested content.

4. The system of claim 1, wherein the instructions are further configured to cause the one or more processors to generate a catch-up list of the requested content based on the viewing progress of the requested content by each viewer.

5. The system of claim 4, wherein the instructions are further configured to cause the one or more processors to:
provide the catch-up list to other viewers in the viewing group; and
track a progress of the other viewers in watching the content on the catch-up list.

6. The system of claim 4, wherein the catch-up list of the requested content includes information indicating which one or more users to complete the catch-up list of the requested content.

7. The system of claim 4, wherein the group viewing is prevented until each viewer completes viewing the catch-up list of the requested content.

8. The system of claim 1, wherein the instructions are further configured to cause the one or more processors to generate a group viewing profile.

9. The system of claim 8, wherein a viewer is blocked from accessing the group viewing profile for group viewing when the viewer's viewing progress is ahead of other viewers' viewing progresses.

10. The system of claim 8, wherein the instructions are further configured to cause the one or more processors to disable one or more of the plurality of viewers from watching the requested content through the group viewing profile based on age appropriateness for the requested content.

11. A method for updating profiles of a plurality of viewers based on streaming progress for a group viewing, the method comprising:
receiving, by one or more processors, a request from a first user to access requested content, the first user associated with a first user profile;
determining, by the one or more processors, that one or more additional user profiles are associated with the requested content in a group viewing context with the first user;
determining, by the one or more processors, viewers, including the first user and which respective users associated with the one or more additional user profiles in the group viewing context, to view the requested content;
monitoring, by the one or more processors, a viewing progress of the requested content by each viewer; and
updating, by the one or more processors, a respective user profile for each viewer based on the viewing progress of the requested content.

12. The method of claim 11, further comprising monitoring a viewing progress of the requested content by a viewer in the viewing group when the viewer watches the requested content independently of other members in the viewing group.

13. The method of claim 11, further comprising determining whether each viewer in the viewing group is allowed to view the requested content.

14. The method of claim 11, further comprising generating a catch-up list of the requested content based on the viewing progress of the requested content by each viewer.

15. The method of claim 14, further comprising:
providing the catch-up list to other viewers in the viewing group; and
tracking a progress of the other viewers in watching the content on the catch-up list.

16. The method of claim 14, wherein the catch-up list of the requested content includes information indicating which one or more users to complete the catch-up list of the requested content.

17. The method of claim 14, wherein the group viewing is prevented until each viewer completes viewing the catch-up list of the requested content.

18. The method of claim 11, further comprising generating a group viewing profile.

19. The method of claim 18, wherein a viewer is blocked from accessing the group viewing profile for group viewing when the viewer's viewing progress is ahead of other viewers' viewing progresses.

20. The method of claim 18, further comprising disabling one or more of the plurality of viewers from watching the requested content through the group viewing profile based on age appropriateness for the requested content.
